(19) United States
(12) Patent Application Publication
(10) Pub. No.: US 2007/0251403 A1
(43) Pub. Date: Nov. 1, 2007

(54) Printing and curing apparatus system and method

(76) Inventor: Kenneth St. John, Norwich, NY (US)

Correspondence Address: SCHMEISER, OLSEN & WATTS, 22 CENTURY HILL DRIVE, SUITE 302, LATHAM, NY, 12110, US

(21) Appl. No.: 11/412,385

(22) Filed: Apr. 27, 2006

(51) Int. Cl. B41M 7/00; B41F 33/16

(52) U.S. Cl. 101/424.1; 101/483

(57) ABSTRACT

A printing and curing apparatus, system and method is provided, wherein the printing apparatus includes an imager and a curing unit and prints design images acquired by the printing and curing apparatus. The printed images are cured according specific parameters of the print design being correlated with the governing operation of the printing and curing apparatus.

### BACKGROUND OF INVENTION

1. Technical Field

This invention relates generally to the field of printing. More particularly, this invention provides for an apparatus system and method for printing designed images and curing the printed images as specifically correlated with the print design.

2. Related Art

An inherent component of printing is the need to make sure that the material(s) (generally ink) deposited by a print device to form a printed image is fixed onto the object onto which the material was deposited. For example, when an image is printed in ink onto a paper, it is ineffectual if the ink smears or does not fixedly attach to the paper because the integrity of the printed image may then be compromised. To prevent smearing or other problems, deposited print material must cure. Curing can occur naturally, as an inherent characteristic of the print material when it encounters the surrounding environment and comes in contact with the object on which it is deposited, or, as is often desirable, curing can be assisted via curing means. Therefore, to increase printing efficiency and ensure printing accuracy, printing devices have incorporated curing means to speed-up curing time and/or facilitate curing of print materials onto objects which the print materials would not otherwise fixedly attach to if not for the assistance of the curing means.

Some known curing means include, oven curing devices, laser curing devices, IR curing devices, LED curing devices, convective curing devices and UV curing devices. In addition various curing means utilize special photo-initiated or microwave sensitive inks. Typical curing devices are usually positioned so that freshly printed objects may encounter the curing devices so that curing can be enhanced. Generally the curing devices are always powered up and are continually using energy, generating heat and often producing ozone emissions. Moreover, the area actively affected by a common curing device is usually much larger than the area of the printed image to be cured. Furthermore, emissions generated by typical curing devices can be damaging to the eyes and harmful to the body. Some known curing devices employ shutter mechanisms to block or unblock the emissions from typical bulbs. However, the operation of the known shutter mechanisms of common curing devices does not specifically correspond with particular print designs. In addition, heat shields are utilized in known devices to prevent the build up of unwanted heat. Further still, common curing devices can be prohibitive of various printing applications because duration of exposure of heat and other emissions generated by common curing devices is destructive to some objects such as thin-film plastics or polymeric textiles. Hence, although known curing means can enhance curing, such means include structural and functional deficiencies and inefficiencies that complicate printing and are not specifically correlated to particular print designs.

Accordingly, there is a need in the field of printing for an improved apparatus system and method for printing and curing.

### SUMMARY OF INVENTION

The present invention provides an apparatus system and method for printing and curing that offers improved reliability.

A first general aspect of the invention provides a printing and curing apparatus comprising: a processor including governing protocol executable for imaging, curing and correlating; an imager, configured to print images having specific print design parameters as directed by the governing protocol of the processor; and a curing unit linked to the imager and configured to cure printed images as directed by the governing protocol, wherein the curing unit includes curing elements configured to be turned on and off during curing as particularly correlated with the specific print design parameters.

A second general aspect of the invention provides a printing and curing method comprising: providing a printing and curing apparatus, the apparatus including: governing protocol having print and cure components; and an imager linked to a curing unit, wherein the imager and the curing unit are directed by the governing protocol; creating a print design having specific design parameters and associating the print design with the governing protocol; locating an object to be printed on and cured by the printing and curing apparatus as the object is oriented with the printing and curing apparatus; printing the print design by the imager on the object as directed by the governing protocol; and curing the printed print design, as directed by the governing protocol, wherein the governing protocol determines a particular area to be cured and a limited time for curing according to the specific print design parameters and correlates the particular area and time for curing with the printed object located and oriented with respect to the printing and curing apparatus.

A third general aspect of the invention provides a printing and curing method comprising: providing an apparatus having an imager and a curing unit both connected to a processor, the processor having governing protocol executable for imaging, curing and correlating, wherein the curing unit includes an array of UV emitters, and further wherein the governing protocol includes print and cure components; linking the print and cure components of the governing protocol to associate physical properties pertaining to the location of the imager as related to the curing unit as included in the printing and curing apparatus; acquiring a print design and associating specific parameters of the print design with the print component of the governing protocol; printing a image as directed by the print component of the governing protocol associated with the print design on an object predictably located with respect to the imager and the curing unit; and curing the printed image by intermittently shuttering the UV emitters of the curing unit to turn them on or off as directed by the cure component of the governing protocol associatively linked with the print design and correlated with the predictably located printed object.

A fourth general aspect of the invention provides a printing and curing system comprising: a printing and curing apparatus having an imager and a curing unit including an array of UV emitters, wherein the printing and curing apparatus performs the steps of: acquiring a print design having specific design parameters; locating an object to be printed on and cured by the printing and curing apparatus as the object is oriented in relation to the imager and curing unit; printing the print design by the imager on the object; and curing the print design printed on the located object, as correlated with a particular area to be cured and a limited time for curing according to the specific print design parameters.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1 depicts a front view of an embodiment of a printing and curing apparatus, in accordance with the present invention;

FIG. 2 depicts a partially cutaway side view of an embodiment of a printing and curing apparatus having a computer slidably exposed, in accordance with the present invention;

FIG. 3 depicts a partially cutaway side view of an embodiment of a printing and curing apparatus having a computer slidably concealed, in accordance with the present invention;

FIG. 4 depicts a top view of an embodiment of a printing and curing apparatus, in accordance with the present invention;

FIG. 5 depicts a schematic view of an embodiment of a product sensing system of an embodiment of a printing and curing apparatus, in accordance with the present invention;

FIG. 6 depicts a side view of an embodiment of a height adjustment detail of an embodiment of printing and curing apparatus, in accordance with the present invention;

FIG. 7 depicts a bottom perspective view of an embodiment of a curing unit of an embodiment of a printing and curing apparatus, in accordance with the present invention;

FIG. 8 depicts a flow chart of an embodiment of methodology relative to printing and curing, in accordance with the present invention;

FIG. 9 depicts a flow chart of an additional embodiment of methodology relative to printing and curing, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

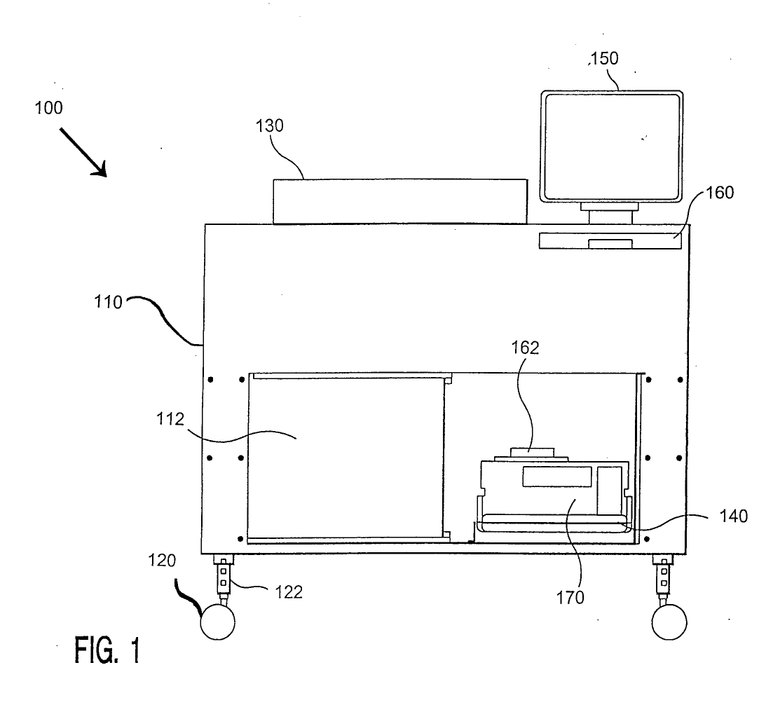

Referring to the drawings, FIG. 1 depicts a front view of an embodiment of a printing and curing apparatus 100, in accordance with the present invention. The printing and curing apparatus 100 may be configured to print and cure images, such as postage indicia, text, wherein the text may be standard type face deposited in any language or fanciful font in any/all colors. Moreover the images may be bar-codes, postage symbols, graphical images, icons, photographic images, and other similar images, wherein the images may have one or multiple colors, hues, and/or degrees of print density. The printing and curing apparatus 100 may be a stand alone work station or may be integrated into other printing facilities and devices. For example, two or more printing and curing apparatuses 100, or other like embodiments, may be physically and electrically linked together to accomplish printing and curing of images in accordance with the invention. As a stand alone work station, the printing and curing apparatus 100 may be physically fixed in one location or may be movable. For instance, the printing and curing apparatus 100 may include rollers 120 positioned at its base to facilitate movement of the apparatus 100. Moreover, the rollers, or other elemental features of the base may be height adjustable, having resilient members 122 cooperating with detents or holes to provide secure versatility to the performance capability of the apparatus 100.

The printing and curing apparatus 100 may include a housing 110, generally located about the apparatus 100 to contain and/or provide structural support to various component features of the apparatus 100. Operable with the housing may be a sliding door 112 that may be manipulated to reveal internal components such as a computer 170 and wireless mouse input 162. The computer 170 may be located on a slide-out tray 140 or other similar component for providing easy access to the computer. Furthermore, the printing and curing apparatus 100 may include a computer monitor 150 or other visual display. The computer monitor 150 may be operable with the computer 170. In addition, the printing and curing apparatus 100 may include a keyboard input 160, which also may be operable with the computer 170. Still further the printing apparatus may include a lid or cover 130 to protect the top part of the apparatus 100. The lid or cover 130 may be clear or opaque. For example, the lid or cover 130 may be formed of clear Lexan plastic.

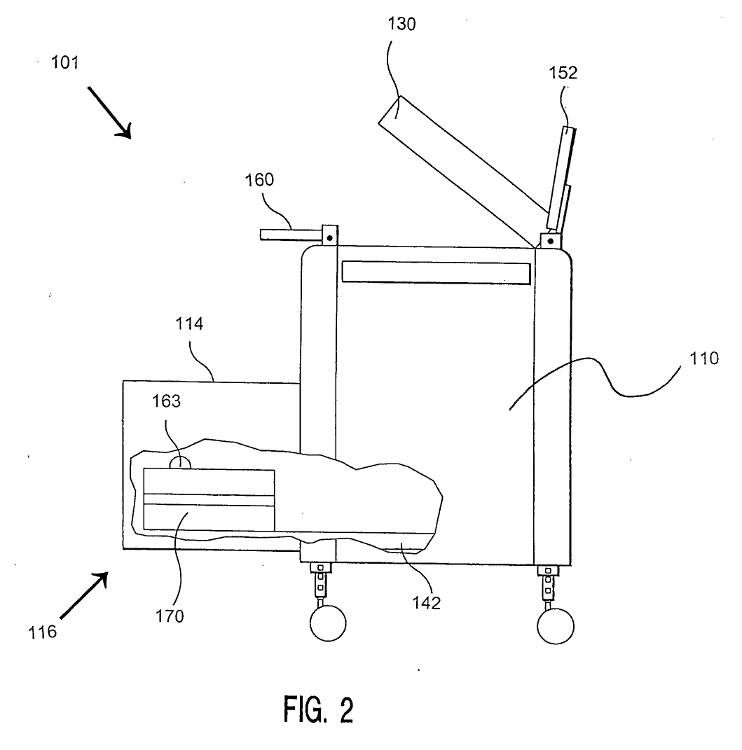

With continued reference to the drawings, FIG. 2 depicts a partially cutaway side view of an embodiment of a printing and curing apparatus 101 having a computer 170 slidably exposed, in accordance with the present invention. The computer 170 may be positioned on a slide-out tray 140 (not shown) which may operate with a tray rail 142. Accordingly, an operator may open the cabinet door 114 and expose the computer 170 by sliding it out as it is positioned on the tray 140 being functional with the tray rail 142. When exposed without the housing 110, the computer 170 may be located in a first position 116. Furthermore, the printing and curing apparatus 101 may include a flat screen monitor 152, a keyboard input 160 and a hardline mouse input 163. As depicted, the lid or cover 130 of the apparatus 101 is shown in an up position being rotatable about hinges placed in the rear of the top portion of the apparatus 101. However, those in the art should appreciate that other feasible mechanical configurations may be implemented to provide movement to the lid or cover 130.

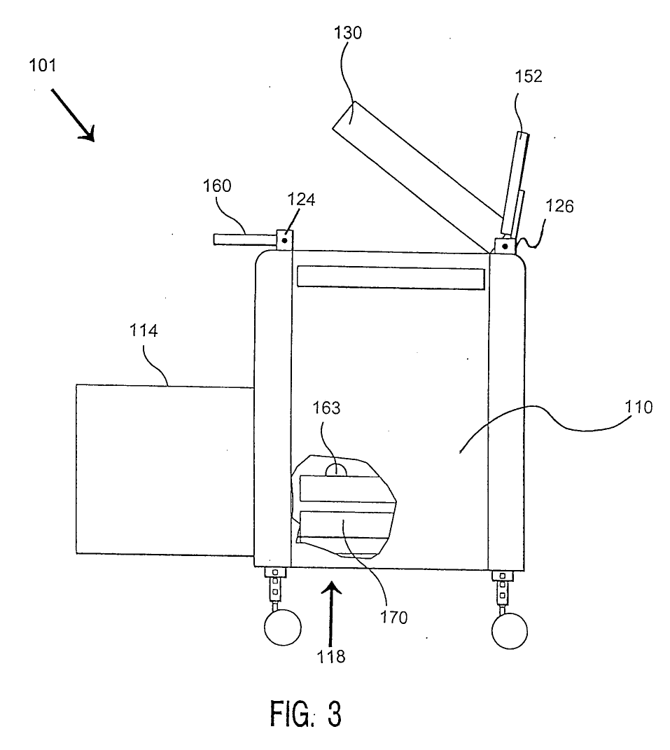

Referring to FIG. 3, which depicts a partially cutaway side view of an embodiment of a printing and curing apparatus 101 having a computer 170 slidably concealed, in accordance with the present invention, the concealment may include location of the computer 170 in a second position 118, wherein the computer 170 is located on a tray 140 (not shown) that is slid along a rail 142 into the housing 110. Those in the art should recognize that the door 114 may be closed so that the computer is completely concealed when residing in a second position 118 within the housing 110. The mouse 163 may also be concealed within the housing 110 when the door 114 is shut. In addition, the printing and curing apparatus 101 may include a releasable/movable keyboard couple 124 for releasably/movably attaching the keyboard input 160 to the apparatus 101. Moreover, the printing and curing apparatus 101 may also include a releasable/movable monitor couple 126 for releasably/movably attaching the monitor 152 to the apparatus 101. Though not shown, it should also be recognized that the lid or cover 130 may also be releasably/movably attached to the apparatus 101. Furthermore, various portions of the housing 110, such as panel sections, may also be configured to releasably attach to the printing and curing apparatus 101.

The computer 170 or similar computing unit of the printing and curing apparatus 100 or 101, or other similar embodiments, may generally comprise and house central processing unit (CPU) or processor, a memory, an input/output (I/O) interface, a bus, I/O devices and a storage unit. The processor performs computation and control functions of the computer 170. The computer 170 processor may comprise a single processing unit, or be operably distributed across one or more processing units in one or more locations (e.g., on a client and server). The computer 170 memory may comprise any known type of data storage and/or transmission media, including magnetic media, optical media, random access memory (RAM), read-only memory (ROM), a data cache, a data object, etc. The computer 170 storage unit is, for example, a magnetic disk drive or an optical disk drive. Moreover, similar to the processor, the computer 170 memory may reside at a single physical location, comprising one or more types of data storage, or be distributed across a plurality of physical systems in various forms. Further, the computer 170 memory can include data distributed across, for example, a local area network LAN, a wireless area network WAN or storage area network (SAN) The computer 170 input or I/O interface may comprise any system for exchanging information to or from an external source. I/O devices may comprise any known type of device, including a display monitor, keyboard, mouse, a GUI interface, a wireless port, a hardline port, and a drive capable of reading retrievable media, printer, speakers, handheld device, facsimile, etc. A bus may provide a communication link between each of the components in computer 170, and may comprise any type of transmission link, including electrical, optical, wireless, ultrasonic, etc.

The input allows the processor of the computer 170 of the printing apparatus 100 to store and retrieve information (e.g., program instructions, governing protocol, or data and/or data sets, such as print designs, postage data and/or mail destination data) from an auxiliary storage device, such as a non-volatile storage device (e.g., a CD-ROM drive which receives a CD-ROM disk) (not shown) and/or from external processors. The processor of the computer 170 can store and retrieve information from other auxiliary storage devices (not shown), which can include a direct access storage device (DASD) (e.g., hard disk or floppy diskette), a magneto-optical disk drive, a tape drive, or a wireless communication device. Moreover the input may be communicatively operable with the processor and configured to receive data, such as data pertaining to print designs.

The memory of the computer 170 may include computer program code or other governing protocol comprising a query generation system that may generate schema mapping-based queries that provide instances of target schemas that are without duplicate elements and satisfy PNF requirements. Governing protocol may be executable for imaging, verifying and curing. Further, the memory of the computer 170 may include other systems not shown in the drawings, such as an operating system (e.g., Linux, or Microsoft Windows XP) that runs on the processor and provides control of various components within and/or connected to the computer 170 and/or the printing apparatus 100 or 101.

Elements of the invention can take the form of an entirely hardware embodiment, an entirely software embodiment or an embodiment containing both hardware and software elements. Furthermore, elements of the invention can take the form of a computer program product accessible from a computer-usable or computer-readable medium providing program code or governing protocol for use by or in connection with a processor or CPU or any instruction execution system to provide and facilitate the capabilities of the present invention. For the purposes of this description, a computer-usable or computer-readable medium can be any apparatus that can contain, store, communicate, propagate, or transport the governing protocol for use by or in connection with the instruction execution system, apparatus, or device.

The medium can be an electronic, magnetic, optical, sonic, electromagnetic, infrared, or semiconductor system (or apparatus or device) or a propagation medium. Examples of a computer-readable medium include a semiconductor or solid state memory, magnetic tape, a removable computer diskette, RAM, ROM, a rigid magnetic disk, a memory stick and an optical disk. Current examples of optical disks include compact disk—read-only memory (CD-ROM), compact disk—read/write (CD-R/W) and DVD.

A processor of an embodiment of a printing and curing apparatus 100 or 101 suitable for storing and/or executing governing protocol, such as program code for directing processing operations, includes at least one processor circuit coupled directly or indirectly to memory elements through a system bus. The memory elements can include local memory employed during actual execution of the governing protocol, bulk storage, and cache memories which provide temporary storage of at least some governing protocol, such as program code in order to reduce the number of times code must be retrieved from bulk storage during execution.

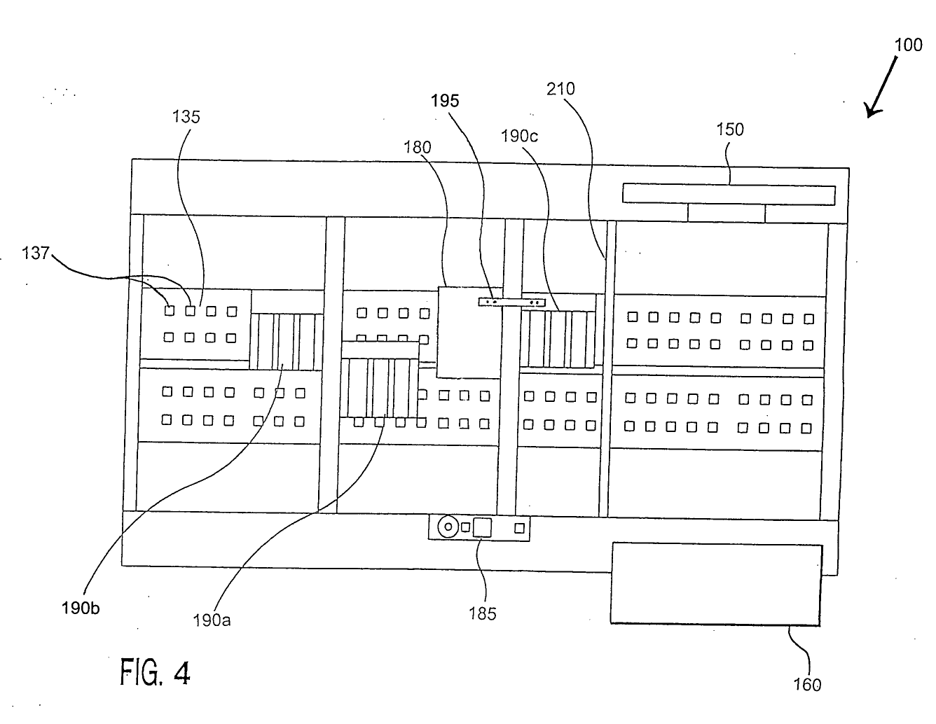

With continued reference to the drawings, FIG. 4 depicts a top view of an embodiment of a printing apparatus 100, in accordance with the present invention. The printing and curing apparatus 100 may include a transporter 135, such as a mail piece conveyer, comprising a belt or other mechanical implement that may be configured to effectively convey objects about the printing and curing apparatus 100 during printing and/or curing. Various non-limiting examples of objects that may be transported included mail pieces, lottery cards printed individually or in sheets in sheets, bar codes on labels, tags, cards or boxes, credit cards, compact disks, and/or other materials that may be printed on. Additionally non-porous substrates may be printed and cured. Moreover, day/date, lot codes and other information may be printed on plastic or similar substrates and may be cured as well. However, those in the art may appreciate that the printing and curing apparatus 100 may be designed such that objects to be printed on, such as mail pieces or lottery tickets, for example, may remain stationary on the printing and curing apparatus 100 while other components such as imagers and curing units are moved to accomplish printing and curing. The transporter 135 may include holding means such as vacuum suction that may be provided through spaced apart holes 137 in the transporter 135. Hence, the transporter 135 may be a vacuum enabled movable belt having holes therein. Those in the art should appreciate that mechanical implements such as catches, flaps, and/or resilient members or like implements may also be utilized to hold the objects to be printed on, such as paper, credit cards, compact disks or mail pieces, in place on the transporter 135 during printing and curing. The transporter 135 may carry objects to be printed on, such as mail pieces, from one end of the printing and curing apparatus 100 to the other. Moreover, objects to be printed on may be carried in multiple directions by the transporter 135.

Located at various positions with respect to the transporter 135 may be an imager 190a or several imagers 190a-c. The location of the imagers 190a-c should be such that materials to be printed on, such as paper products, credit cards, compact disks, mail pieces or other articles being conveyed by the transporter 135 may be positioned so that the imagers 190a-c may readily print images on the materials to be printed on. The images printable by the imagers may include, but are not limited to, postage indicia, alphanumeric symbols, typographic symbols, photographic images, icons, computer enhanced images and/or other images capable of being printed in one or multiple colors on materials such as mail pieces, paper products, credit cards, compact disks, cloth, synthetic products metals, composites, and/or other like materials and/or combinations of materials. A first imager, such as imager 190c, may be configured to print a designed print image, on an object as directed by the governing protocol of the processor. The designed print image may be created by and stored in the computer 170 by a user of the printing and curing apparatus 100. Moreover the designed print image may be imported from another device external to the printing and curing apparatus 100.

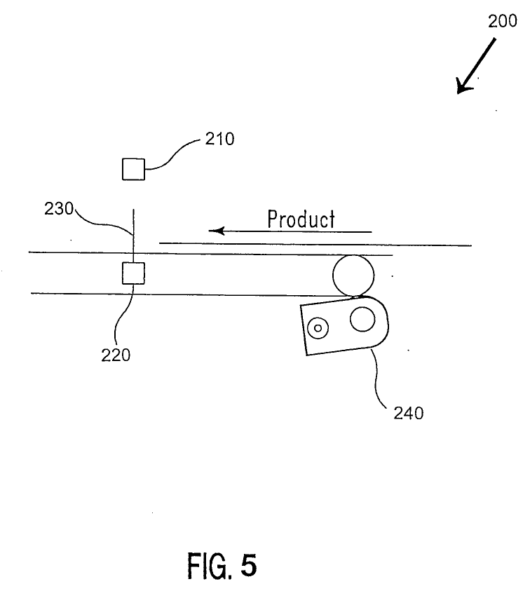

Referring further to FIG. 4, a printing and curing apparatus 100 may include a curing unit 180. Curing may be specifically correlated with the designed images. The curing unit 180 may also be operable with the transporter 135 and may be pulsed, shuttered, or otherwise turned on and off based on the precise particular and/or specifically predicable position (as possibly determined by sensors and/or encoders discussed in greater detail in reference to FIG. 5) of the designed printed images to be cured. The curing unit 180 may be configured to cure designed images, such as postage indicia, lottery ticket bar codes, photographs, or other images printed by the imager(s) 190a-c on the objects to be printed on, such as mail pieces, credit cards, etc., and in specific relation to the corresponding design of the print image. The processor may execute the governing protocol to create or retrieve a print design. Moreover, the processor may execute the governing protocol to correlate the print design with the operation of the curing unit, which may itself include a processor. Furthermore, the processor may execute the governing protocol to compare the operation of the curing unit with the location of the object to be printed and cured in relation to the designed image and determine whether the curing is or will be effective in relation to the image when or after it is printed.

The curing unit 180 may be connected to an imager, such as imager 190c, via a linkage 195. The linkage 195 may be a physical linkage, an electrical linkage, or both a physical and an electrical linkage. Accordingly, when the linkage 195 is physical in nature, it may serve to position the curing unit 180 in a fixed location as related to the imager 190c. Moreover, when the linkage is electrical in nature, it may serve to promote operation of the curing unit 180 in relation to the operation of the imager 190c, by electrically tying the control of the two components together. The linkage may act physically and electrically with the product sensing bar 210. Hence the linkage may associatively locate the curing unit 180 and the imager 190c in relation to the sensing bar 210. Furthermore, the linkage may electrically communicate product sensing information associated with sensing bar to the curing unit 180 and/or the imager 190c.

Additional imagers, such as imagers 190a-b, may be configured to print other images, or different portions of the designed image. For example, a second imager 190a may print images separate from the design image printed by imager 190c, as directed by the governing protocol of the processor. Moreover, a third imager, such as imager 190b, may print additional portions pertinent to the previously printed designed image following curing exposure by the curing unit 180. Those in the art should appreciate that additional curing units (not shown) may be included in the printing and curing apparatus 100, and configured to cure designed images printed by additional imagers 190a-b.

Referring further still to FIG. 4, the printing apparatus 100 may include a control panel 185. The control panel may provide operator ability to control the printing and curing process. Furthermore, the printing and cuing apparatus 100 may include a print product sensor detector bar 210. Moreover, the monitor 150 may be utilized to provide information relative to the printing and curing process. Additionally, the keyboard input 160, mouse 162,163 (shown in FIGS. 1-3), or other user interface device may operate with the control panel to affect the printing and curing process.

With continued reference to the drawings, FIG. 5 depicts a schematic view of an embodiment of a print product sensing system 200 of an embodiment of a printing and curing apparatus 100, in accordance with the present invention. The print product sensing system 200 may include a product sensing detector bar 210 working in conjunction with an emitter 220 to detect objects or materials to be printed on. The emitter 220 may emit any electromagnetic emission 230, such as a light beam and/or any sonic emission. The detector bar 210 may be configured to detect the emissions from the emitter 220. Additionally, the detector bar need not be a physical bar, but may be any device capable of detecting the emissions from the emitter 220. Objects to be printed on may be introduced into the printing and curing apparatus 100 in such a manner as to describe a lead edge or other indicator of the beginning of a printable area. Examples of this may be a photocell trigger by a lead edge of a single piece, a mark detected on a web to indicate a single print area on a continuous web, or a count and repeat generated trigger working on an unmarked continuous form. Moreover, X,Y,Z coordinate axis may be associated with a printable area and correlated with printing and curing operations as identified by the product sensing system 200 working in conjunction with the governing protocol of the processor. The printable area may be configured to pass under the imaging components, such as imagers 190a-c, then to the curing unit 180.

The print product sensing system 200 may also include an encoder 240. The encoder may be a bar code reader, camera, or other similar implement that may be able to track, trace, scan capture and/or identify images, such as postage indicia and other printed images. The emitter 220, detector 210 and/or encoder 240 may be stationary, or may be moveable to accomplish the objects of the invention.

The print product sensing system 200 may work in conjunction with the curing unit 180 to facilitate the print design correlated curing of printed images, such as specifically curing a particular bar code printed on a lottery ticket, which may have other printed material such a text or graphics included in the overall print design. The output of the various component elements individually or as a whole of the print product sensing system 200 output may be linked to a governing printing and curing control processor to insure that the system's sensing, printing and curing is correct.

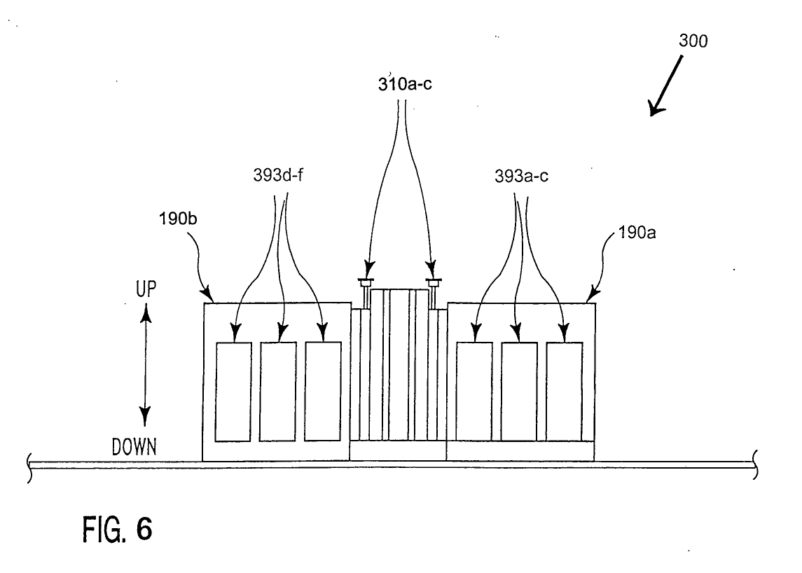

With additional reference to the drawings, FIG. 6 depicts a side view of an embodiment of a height adjustment detail 300 of an embodiment of printing and curing apparatus 100, or other similar embodiment, in accordance with the present invention. The height adjustment detail 300 may include height adjustment knobs 310a-c, which may adjust the height of imagers 190a-c. The imagers 190a-c may each include ink cartridges. For example, imager 190a may include three ink cartridges 393a-c, where imager 190b may include three different ink cartridges 393d-f. The ink cartridges may contain various inks of various colors, wherein the ink is operable to be efficiently and fixedly printed on objects to be printed on such as paper product, a mail piece, credit cards, compact disks or other products that may be printed on. The height adjustment detail may include ink jet printing modules, at least one of which, such as imager 190c, may contain UV-curing ink. The UV-curing ink may be a typical aqueous or solvent-based ink that may be operable with common ink jet printing modules or other like imagers. The ink may also be special photo-initiated or microwave sensitive ink; although those types of ink are not necessary for curing.

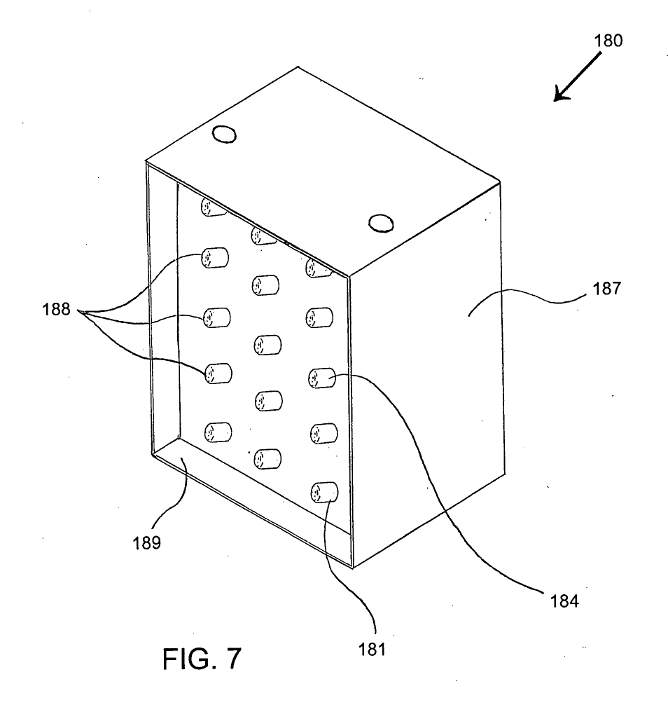

A bottom perspective view of an embodiment of a curing unit 180 of an embodiment of a printing and curing apparatus 100, as shown in FIG. 7, reveals that the curing unit may include a housing 187 having a bottom rim 189. Located on or near a bottom surface of the housing may be a curing element such as a UV emitter 181, or an array of curing elements such as UV emitters. The UV emitters may produce ultraviolet (UV) emissions. Hence, the curing unit 180 may contain at least one and/or an array of UV emitting elements. One embodiment may include UV emitting light emitting diodes (LEDs) operable as UV emitters. The UV emitters may be configured to be pulsed, shuttered, or otherwise turned on an off intermittently. For example, a group of three UV emitters 188 may be pulsed on at the same time as UV emitter 184, while UV emitter 181 may be pulsed off. Moreover, shutter mechanisms may be provided to shield or expose emissions from a UV emitter 181 or group of UV emitters 188. The shuttering of the UV emitters, such as UV emitter 181, may turn on or off the UV emissions and thereby turn on or off curing. The shutter mechanisms may be configured to work in conjunction with the housing 187 and or bottom rim of the curing unit 180. Additionally, the operation of a shutter or shutters may be facilitated by movement of an associated belt or plurality of belts. Furthermore, other implement such as interlocks, bistable snapping mechanisms, resilient components and or other like devices may be employed to operate a shutter or shutters.

Any combination of UV emitters may be turned on or off. For instance, all the UV emitters located nearest the rim 189 may be shuttered off while the UV emitters in the middle, away from the rim may remain exposed and on. Then, after some period of time, the outside UV emitters nearest the rim 189 may be unshuttered and turned on while the UV emitters in the center away from the rim may be shuttered off. Moreover, a plurality or array of UV emitters may be located in any spaced configuration. For example, an UV emitting LED array may be shaped like a target, having a central LED with circular LED ring patterns concentrically surrounding the center LED. Furthermore, groups of UV emitters may be spaced closer together or farther apart than other groups. Still further, the UV emitters may be similar in type, size, and output intensity. However, the UV emitters may also vary in type, size and/or output intensity. For instance, a central group of UV emitters in an array may be comprised of UV emitting LEDs, while an outer rim of UV emitters in the same array may be comprised of UV bulbs containing mercury vapor or other gasses encapsulated in glass quartz or other materials suitable for short-wave, middle-wave and/or long-wave UV emissions in the UV spectrum to pass through. UV emitters may also include filters to restrict or pass specific wave-lengths.

The curing unit 180 may be communicatively linked to a processor of the computer 170 and may be operable with governing protocol executable by the processor. Moreover, the curing unit 180 may also be communicatively linked to an imager, such as imager 190c and/or to a product detector, such as sensing bar 210. In addition, the curing unit may include a processor capable of interpreting data according to pre-established logic controls or in relation to communications received from the processor of computer 170.

The size and shape of the curing unit 180 may vary according to desired printing and curing capability. For example, a printing and curing apparatus embodiment may be created to print and cure large (such as 1-4 square feet) print areas. Yet, other embodiments of the printing and curing apparatus may be created to print and cure small (0-50square millimeter) print areas. Moreover, the shape of a curing unit need not be box-like as depicted in FIGS. 4 and 7. For instance, a curing unit 180 may be pyramidal with a triangular base or may be semi-spherical. Those in the art should recognize that the size and shape of a curing unit and of embodiments of a printing and curing apparatus in general may be dictated by the ultimate desired use for the apparatus. A curing unit may be configured to be located on or in relation to a printing and curing apparatus so that designed print images may pass into operable position with the curing unit. In other words, if a particular print design includes a portion of the printed image that needs to be cured, the printing and curing apparatus may have means whereby the portion of the design following printing is cured by the curing unit. As an example, a mail piece may be comprised of a plastic material onto which a postage indicia image must be deposited. A print design including the location of the postage indicia image with respect to the mail piece may be generated and the image may be printed accordingly. Then the mail piece may be passed under the curing unit and those UV emitters proximate the printed postage indicia design image may be turned on while and when the image specifically passes under the UV emitters. Hence only the UV emitters necessary to cure the designed image may be turned on and only at and for that period of time necessary for curing as determined by the parameters of the print design in correlation with the dynamic location of the mail piece with respect printing and curing apparatus 100.

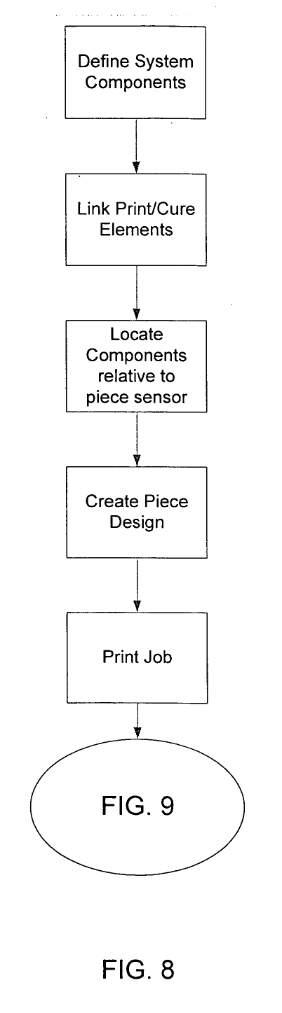

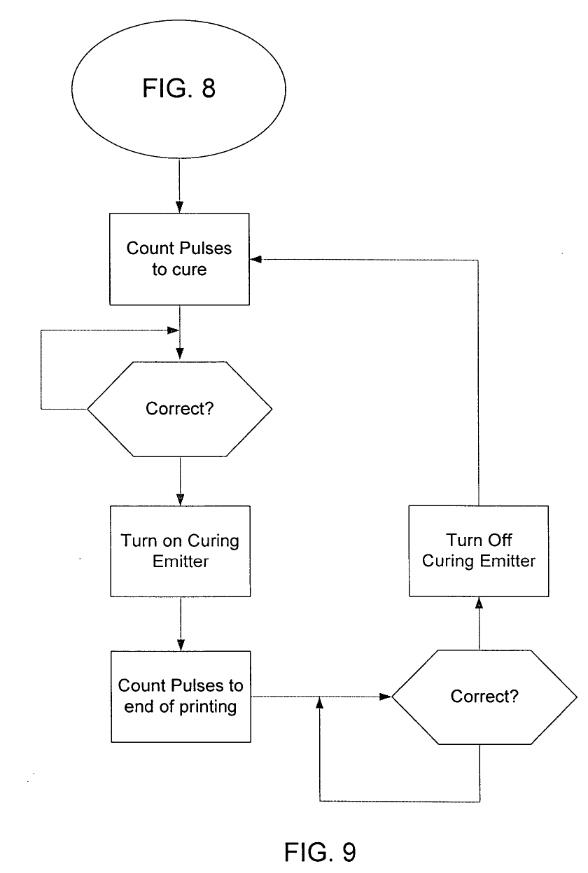

A printing and curing method 400 is now described with reference to FIGS. 1-9. As part of the method, a printing and curing apparatus, such as apparatus 100 or other comparable embodiments, may be provided. The printing and curing apparatus may include a computer program product accessible from a computer-usable or computer-readable medium providing program code or governing protocol for use by or in connection with a processor or CPU or any instruction execution system to provide and facilitate the capabilities of the present invention. The governing protocol may include at least two components: a print component and a cure component. The print component may govern the control of the deposition of print material, such as ink, onto a substrate or object to be printed on, such as a piece of paper, according to particular print design parameters. The print design parameters may be associated with a print design created by a user of the printing and curing apparatus 100. For example, a user may generate text in a word processing software package operating on and processed by the computer 170 or a user may create a CAD drawing or other graphical rendering using software or via a scanning operation. The text or graphic may then be driven or converted into encoded image data associated with the ultimate image design of the text and/or graphics to be printed. Moreover, a user may utilize layout tools in control software operating on the computer 170 to create a piece design which comprises elements of fixed or variable text or graphics, photographs, bar codes and other like images. For instance, a piece design may virtually locate a print design in a virtual area correlated with an actual area of an object or piece to be printed on. In this manner, a user may be able to virtually or digitally layout or map where a print design will be located on a piece or object to be printed on. Those in the art should recognize that a print design and/or virtual piece layout need not be created by a user of the printing and curing apparatus 100. Rather, a user may simply acquire, retrieve or import an already generated print design and/or a virtual piece layout and then associate the design and/or virtual piece layout with the governing protocol. For instance, a user may retrieve a print design and/or a piece layout that may be stored in memory in the computer 170. Still further, a user may also import a print design and/or a piece layout from another device, wherein the device is communicatively linked to the printing and curing apparatus 100 and associated with the governing protocol.

Once a print design has been created or acquired, then the print component of the governing protocol may facilitate the conversion of the design from virtual parameters to a real image. In other words, the print component may direct, manipulate and prepare the print design for printing. Moreover, the print component of the governing protocol may dictate how the design may be realized through actual deposition of material by an imager, such as an imager 190a-c, onto a substrate such as a piece of paper or other object to be printed on.

The cure component of the governing protocol may govern the curing of print materials following deposition and according to particular cure design parameters. Similar to the print component, cure design parameters may be associated with a print design created by a user of the printing and curing apparatus 100. The cure component of the governing protocol may determine a particular area to be cured and a limited time for curing according to the specific print design parameters. For example, a user may retrieve an image designed by another device and communicated to the printing and curing apparatus 100. The image may then be driven or converted into encoded image data associated with the ultimate image design of the retrieved text and/or graphics, or portion of the image design of the text and/or graphics to be cured. The overall area of the image and the time for curing may also be determined. Moreover, a user may utilize layout tools in control software operating on the computer 170 to create a piece design which comprises elements of fixed or variable text or graphics, photographs, bar codes and other like images. For instance, a piece design may virtually locate a print design in a virtual area correlated with an actual area of an object or piece to be cured. In this manner, a user may be able to virtually or digitally layout or map where the curing of a print design will be located on a piece or object to be cured. It should be recognized that an entire print design can, but need not be cured. Accordingly, different portions of a print design may be cured depending on print density, such as dpi, color, type of print material, such as ink, to be deposited, type of substrate or object to be printed on, the number of or speed at which a batch of similar print pieces may be mass processed, how a print piece will be handled following printing, and/or other factors that may affect printing and/or any combination thereof. For example, a print design associated with printing on a mail piece may be created and only the postage indicia may need to be cured while the addressee information provided as text in the overall print design may not need curing. Thus the cure component may facilitate the conversion of the mail piece print design from virtual parameters to a real area associated with the mail piece and correlated with the print design, wherein all or a portion of the design may be cured. In other words, the cure component of the governing protocol may direct and prepare the particular portion of the design, such as the postage indicia, for curing. Moreover, the cure component of the governing protocol may dictate how the design may be cured by a curing unit, such as curing unit 180, following actual deposition of material by a imager, such as imager 190a-c, onto a substrate such as a piece of paper or other object to be printed on. Accordingly, the curing component may correlate the particular area and time for curing with a printed object located and oriented with respect to a printing and curing apparatus, such as a printing and curing apparatus 100.

An embodiment of a step in the methodology of printing and curing of the present invention may be to define system components 405, such as printing and curing components of a printing and curing apparatus 100. Such defining 405 may be accomplished via governing protocol that may govern the printing and curing capabilities of the apparatus 100. Hence, where it is desirable to cure on demand or to cure according to and in correlation with print design (cure by design), it is necessary to provide a curing component as well as a printing component relative to the governing protocol of the apparatus 100.

Another step embodied in the method of printing and curing may be to link the print and cure components 410 of the governing protocol. The linkage 410 provides association between the printing and curing capabilities of the printing and curing apparatus 100. That is the apparatus may be able to distinguish curing as related to printing. In particular, it is possible that not all print deposits will be cured. Hence, the link 410 is necessary to assure that the printing and curing apparatus effectuates curing for only specifically designated portions of a printed image. The link 410 between the components may associate physical properties pertaining to the location of an imager, such as and imager 190a-c as related to a curing unit, such as curing unit 180 and/or as related to a printing and curing apparatus 100 itself. Moreover, the link 410 may be an electromagnetic, or sonic connection facilitating the exchange of information between a processor and an imager and/or a curing unit. Accordingly, as directed by various components of the governing protocol, a printing apparatus may operate in linked functionality with a curing unit. This functionality may include operable relationship between performance of imaging/printing in association with curing performance over a period of time.

In addition, the linking functionality may associate printing and curing operation as related to the performance of such at a specific location on the apparatus 100. A step embodied in the method of curing and printing may be to locate the print and cure components 415 relative to an object to be printed and cured by the apparatus 100 or a specific location or component of the apparatus such as a product sensing bar 210 of a product sensing system 200. The location of printing and curing may be dynamic. For example and imager, such as imager 190a-c, and/or a curing unit, such as curing unit 180, may move relative to each other and the apparatus 100. The may also may move relative with respect to a product sensing system 200. Furthermore, a print piece or object to be printed on may move relative to the imager 190a-c, the curing unit 180, the product sensing system and/or the apparatus 100. Therefore, the link 410 may be dynamic with respect to time and location of operation of both printing (imaging) and curing and as possibly related to the location 415 of a product sensing system 200, thereby facilitating a correlation of operation between the printing and curing functions of a printing and curing apparatus, such as apparatus 100 or other comparable embodiments.

An additional step embodied in a method of printing and curing may be to create a piece design 420 of a print image. The design may be created 420 by a user utilizing software incorporated into the computer 170 of a printing and curing apparatus 100, or the design may be created 420 by another device and merely acquired by a user and incorporated into the printing and curing apparatus 100. Moreover, a user may utilize layout tools in control software operating on the computer 170 to create a piece design 420 which comprises elements of fixed or variable text or graphics, photographs, bar codes and other like images. The print design may then be driven or converted into encoded image data associated with the ultimate piece design of the image to be printed. In other words, the virtual embodiment of the design may be converted to equate with mechanical structure and functionality of the printing and curing apparatus 100 as facilitated by print design image data. For example, the colors, hues, scales, density, resolution and placement of image elements, may be transformed into binary or other digitally or electromagnetically operable data. Everything pertaining to the design image may be converted into numerical or symbolic terms that may be read by machines and processed according to governing protocol. Additionally, the physical size and operation of the printing and curing apparatus 100 may also be correlated with numbers of symbols representing, inter alia, location and time, etc.

Once the piece design of a print image created, a link 405 between the printing components and the curing components of the printing and curing apparatus 100 may facilitate the correlation of the print design with curing. For example, any print design element that is to be printed by an imager and is linked to a curing unit may be highlighted for curing by adding the cure process as a part of a properties window or similar technique. For instance, a user may call up the piece design of a print image and then initiate a drop-down menu that includes a highlighting tool that allows the user to select particular portions of the print design image that are desired to be cured. Not all elements of the design image to be printed by the linked imager need be cured. The highlighting may numerically or symbolically equivocate the highlighted portion with image data linked to and operable with a curing unit. Accordingly, portions of the print design set aside for curing may be linked dynamically with respect to time and position with an imager, such as an imager 190a-c, a curing unit, such as curing unit 180, a product sensing system 200 and/or with the apparatus 100 generally.

Once the piece design of a print image is created and operable with the printing and curing apparatus 100, then an additional step embodied in a method of printing and curing may be to print a job 425. Printing a job 425 requires associating the position of a print piece or object to be printed on with the printing and curing apparatus 100. In particular, if the piece to be printed on correlates with the piece design of a print image, then it is necessary to assure that the print piece or object to be printed on is properly and/or predictably oriented so that the design image may be properly deposited on the print piece or object to be printed on. The orientation of the object to be printed on may be facilitated by locating, detecting or sensing pieces or objects of known or predictable dimension on a known or predicable location of the printing and curing apparatus, such as apparatus 100, and then possibly moving the pieces at a known velocity to and/or through a known location on or relative to the apparatus 100. In addition, a piece or object may be placed on or with a printing and curing apparatus 100 and then the orientation of the piece, with respect to the printing and curing apparatus 100 may be determined after placement. The orientation may be detected and/or described by a product sensing system such as system 200 of a printing and curing apparatus 100. For instance, an object to be printed on may be introduced into the printing and curing apparatus 100 in such a manner as to describe and/or detect a lead edge or other indicator of the beginning of or at some identifiable location of a printable area. The printable area may correlate with the piece design of a print image. Examples of piece detection may be a photocell trigger by a lead edge of a single piece, a mark detected on a web to indicate a single print area on a continuous web, or a count and repeat generated trigger working on an unmarked continuous form. The printable area may pass under the imaging components and then on to and under the curing unit, or the imaging components and/or the curing unit may be passed over the printable area.

Once a print job 425 runs, the linked cure component of the governing protocol may determine when and how to cure particular printed images or portions of printed images. This determination may be made by the correlation of the original piece design print image and the dynamic orientation of the printed object with respect to the printing and curing apparatus 100. For example, a time period relative to the change from a first orientation of the object with respect to an imager for printing to an operable second orientation of the object with respect to a curing unit for curing may be deduced by analyzing the predicted or known velocity of orientation change with respect to the size and location of a printed area to be cured and the associated distance between printing and curing locations. Hence, one embodiment of a step in a method of printing and curing may be to count pulses to cure 430. For instance, the governing protocol may direct the counting of pulses 430 from an encoder. Using these pulses, the governing protocol may direct a comparison between the virtual print area associated with the piece design of a print image with the detected location of the actual lead edge or other indicator of the location of the printed area to be cured and then count a defined number of pulses until the printed area to be cured is actually or predictably in operable orientation with the curing unit.

Moreover, as curing inherently takes some period of time, an additional step embodied in a method of printing and curing may be to keep counting until a correct number of pulses is attained 435. For example, a user may know, or may be privy to knowledge corresponding to the time necessary for curing the printed area. This cure time may be derived by the computer 170 or another computing device from image data relative to the print design image. For instance, the density of the ink deposited, the color, the resolution, the substrate upon which it was deposited, the type of imager doing the depositing and the approximate time for operable location with respect to the curing unit may all contribute to the amount of time a print area needs to be cured. Thus, if a printed area has a high density of printed material deposited on a non-permeable substrate, then that printed area will likely need to cure longer than a different low density printed area printed on a non-permeable substrate. Counting correctly determined pulses 435 may limit curing to only what is necessary. Accordingly, if a UV curing unit is being utilized, then UV exposure may be reduced to only the particular amount of time that is necessary to cure a particular print area.

As such, an additional step embodied in a method of printing and curing may be to turn on a curing element 440, such as by opening a shutter or shutters associated with a UV bulb or by pulsing a UV emitting LED, of a UV curing unit 180 of a printing and curing apparatus 100, only at an appropriate time corresponding to the printing of a particular print area. This time may be associated with the dynamic orientation the exact edge of the curable print object, or some constant number of pulses less than that point to allow for the opening and/or closing of a shutter or for a brief warm up of a bulb or LED. Moreover, where the printed image encompasses only a portion of the curing area of a curing unit, then only those UV emitters that correlate with the particular portion of the print design to be cured need to be turned on. The other UV emitters, those not located near the correlated particular print design area, do not need to be turned on, thereby further reducing the generation of heat, the consumption of energy, and/or the overall exposure to UV emissions.

Once turned on for curing, another additional step embodied in a method of printing and curing may be to count pulses to the end of the print area 445. Accordingly, as described above, the curing time may be determined relative to the particular print area of the particular piece design of a print image to be cured. Hence the governing protocol may direct the curing unit to continue to cure as long as needed in order to effectuate a proper setting and curing of the ink or other materials deposited on the printed piece. Accordingly, if the curing unit is a UV curing unit, such as curing unit 180, then the appropriate UV emitters may be turned on and left on until the orientation of the print area is no longer operable with the UV emitters or until such time as is needed to effectuate a proper cure.

Furthermore, an additional step embodied in a method of printing and curing may be to compare the count to the number known or determined in relation to the piece design of a print image to make sure the comparison is correct 450. Accordingly, the governing protocol may compare the number of pulses actually counted to the number of pulses correlating with the amount determined to be needed through evaluation of the print image. Hence, once the actual count is equal to the determined count correlating with the print design, then a last step pertaining to an embodiment of a method of printing and curing may be to turn of the curing unit 455 and wait for the next directive to cure, such as a directive from the governing protocol to count pulses to cure 430. Thus, if the curing unit is a curing unit such as curing unit 180, then the appropriate UV emitters may be turned off. Such a directive to turn off the curing unit may also be provided by the curing component of the governing protocol in response to the next lead edge trigger or as otherwise directed by the curing component of the governing protocol in correlation with the print design.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. A printing and curing apparatus comprising:
a processor including governing protocol executable for imaging, curing and correlating;
an imager, configured to print images having specific print design parameters as directed by the governing protocol of the processor; and
a curing unit linked to the imager and configured to cure printed images as directed by the governing protocol, wherein the curing unit includes curing elements configured to be turned on and off during curing as particularly correlated with the specific print design parameters.

2. The printing and curing apparatus of claim 1, wherein the curing elements are shuttered UV emitters.

3. The printing and curing apparatus of claim 1, further comprising a print product sensing system linked to the imager and configured to detect print area orientation and location as correlated with the specific print design parameters.

4. The printing and curing apparatus of claim 1, further comprising a transporter configured to effectively convey objects about the printing and curing apparatus.

5. The printing and curing apparatus of claim 3, wherein the transporter is a vacuum enabled movable belt.

6. The printing and curing apparatus of claim 1, further comprising a display monitor.

7. The printing and curing apparatus of claim 1, wherein the processor is housed in a computer.

8. The printing and curing apparatus of claim 1, wherein the imager an ink jet printer configured to deposit ink selected from the group consisting of either aqueous or solvent-based UV curing ink.

9. A printing and curing method comprising:
providing a printing and curing apparatus, the apparatus including:
governing protocol having print and cure components; and
an imager linked to a curing unit, wherein the imager and the curing unit are directed by the governing protocol;
creating a print design having specific design parameters and associating the print design with the governing protocol;
locating an object to be printed on and cured by the printing and curing apparatus as the object is oriented with the printing and curing apparatus;
printing the print design by the imager on the object as directed by the governing protocol; and
curing the printed print design, as directed by the governing protocol, wherein the governing protocol determines a particular area to be cured and a limited time for curing according to the specific print design parameters and correlates the particular area and time for curing with the printed object located and oriented with respect to the printing and curing apparatus.

10. The printing and curing method of claim 9, further comprising linking the print and cure components of the governing protocol to assure that the printing and curing apparatus effectuates curing for only specifically designated portions of the printed print design.

11. The printing and curing method of claim 9, wherein curing is effectuated by an array of UV emitters included in the curing unit.

12. The printing and curing method of claim 11, wherein certain UV emitters of the array are turned on for specific periods of time during curing while certain other UV emitters are turned off during the same period of time, and wherein the on/off condition of the UV emitters is directed by the governing protocol as correlated with the print design.

13. The printing and method of claim 12, wherein the period of time is associated with the dynamic orientation the exact edge of the curable object to be printed on.

14. The printing and curing method of claim 12, wherein the period of time for turning UV emitters on is determined by counting pulses to cure, further wherein the pulses to cure are determined by correlation with the particular area to be cured.

15. The printing and curing method of claim 14, wherein a period of time of having the UV emitters turned on before turning them off is determined by continuing to count pulses until a correct number of pulses is attained, further wherein the correct number of pulses is correlated with the end of the particular area to be cured.

16. The printing and curing method of claim 15, further including comparing the number of pulses actually counted to the number of pulses correlating with particular area to be cured and turning off the UV emitter when the counts are equivalent.

17. The printing and curing method of claim 9, wherein the imager is an ink jet printer configured to print the print design using ink selected from the group consisting of aqueous or solvent-based UV curing ink.

18. A printing and curing method comprising:
providing an apparatus having an imager and a curing unit both connected to a processor, the processor having governing protocol executable for imaging, curing and correlating, wherein the curing unit includes an array of UV emitters, and further wherein the governing protocol includes print and cure components;
linking the print and cure components of the governing protocol to associate physical properties pertaining to the location of the imager as related to the curing unit as included in the printing and curing apparatus;
acquiring a print design and associating specific parameters of the print design with the print component of the governing protocol;
printing a image as directed by the print component of the governing protocol associated with the print design on an object predictably located with respect to the imager and the curing unit; and
curing the printed image by intermittently shuttering the UV emitters of the curing unit to turn them on or off as directed by the cure component of the governing protocol associatively linked with the print design and correlated with the predictably located printed object.

19. The printing and curing method of claim 18, wherein the print design is acquired by creating the image via software operable with the processor.

20. The printing and curing method of claim 18, wherein the print design is acquired by importing the print design from another device.

21. The printing and curing method of claim 18, further comprising actually locating the object to be printed on with respect to the imager and the curing unit.

22. The printing and curing method of claim 18, wherein the intermittent shuttering of the UV emitters of the curing unit to turn them on or off is directed by counting pulses to cure, further wherein the pulses to cure are determined by correlation with the associatively linked print design.

23. The printing and curing method of claim 22, wherein the counted pulses to cure are compared with the number of pulses to cure determined by correlation with the associatively linked print design and the UV emitters are shuttered and turned off when correlated and counted pulses match.

24. A printing and curing system comprising:
a printing and curing apparatus having an imager and a curing unit including an array of UV emitters, wherein the printing and curing apparatus performs the steps of:
acquiring a print design having specific design parameters;
locating an object to be printed on and cured by the printing and curing apparatus as the object is oriented in relation to the imager and curing unit;
printing the print design by the imager on the object; and
curing the print design printed on the located object, as correlated with a particular area to be cured and a limited time for curing according to the specific print design parameters.

25. The printing and curing system of claim 24, wherein the curing is effectuated by intermittently shuttering on and off the UV emitters according to a pulse count associated with the specific print design parameters.

26. The printing and curing system of claim 24, wherein the imager is an ink jet printer and the print design is printed by the imager, wherein the ink selected from the group consisting of aqueous UV-curing ink or solvent-based UV-curing ink.
